(19) United States
(12) Patent Application Publication
(10) Pub. No.: US 2010/0031513 A1
(43) Pub. Date: Feb. 11, 2010

(54) Scraper Blade Assembly Structure

(76) Inventor: Wen-Chen LIN, Taichung City (TW)

Correspondence Address: RABIN & Berdo, PC, 1101 14TH STREET, NW, SUITE 500, WASHINGTON, DC, 20005, US

(21) Appl. No.: 12/187,012

(22) Filed: Aug. 6, 2008

(51) Int. Cl. B26B 3/00

(52) U.S. Cl. 30/169

(57) ABSTRACT

The invention relates to a scraper blade assembly structure. The scraper basically comprises a stem for hand grip and a scraping section in the front. The invention provides fast replacement and firm assembly for scraper. The scraping section of the scraper comprises a jaw plate, a blade and a fastening button. The jaw plate extends backward to form an arm. The jaw plate is attached to the inside of the jaw plate groove of the scraping section by a fastener that also serves as a lever pivot for swinging back and forth. When a fastening button goes into the inside of the jaw plate of the scraping section, it pushes the inner side of the arm of the jaw plate, and so as to generate a great holding power for the front of the jaw plate that can facilitate fast replacement and firm assembly for the scraper blade. Further, the fastening button can be a handle protruding from one side of the scraping section to facilitate the user to exert stronger force for effective scraping.

### BACKGROUND OF THE INVENTION

1. Field of the Invention

The invention relates to a tool to remove surface residues in a remodeling project, especially for a scraper blade assembly structure. It is mainly to provide fast replacement for blade, firm assembly and a front stem for strong grip for effective stripping.

2. Description of the Prior Art

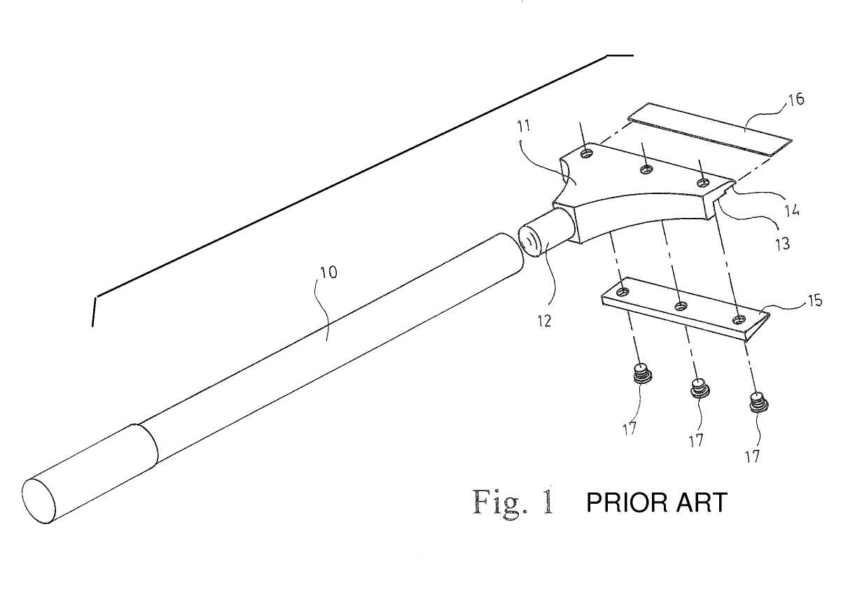

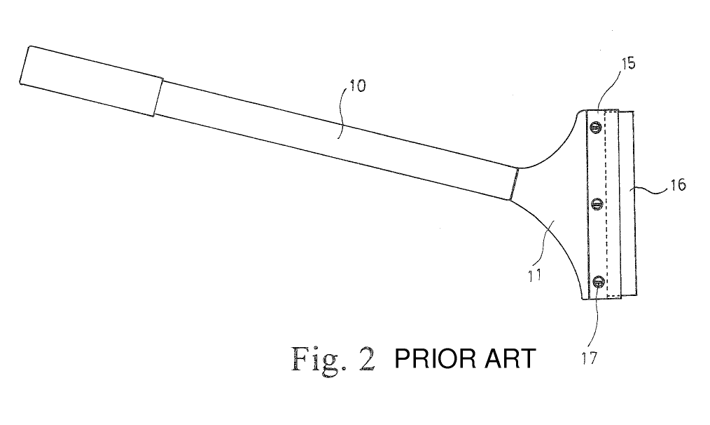

To assure the flatness in replacing wallpaper or carpet, it is necessary to remove the surface adhesive residue first. FIG. 1 and FIG. 2 show the structural disassembly diagram and assembly diagram for a known scraper. The scraper comprises a stem 10 for grip and a scraping section 11 at the front end. The back end of the scraping section 11 forms a connecting section 12 that can connect with the stem 10. At the front end there is a jaw 13 and a blade base 14 to accommodate a jaw plate 15 and a blade 16 in assembly. Through screws 17 tightening the jaw plate 15 and the scraping section 11, the jaw plate 15 in the jaw 13 squeezes the blade 16 and therefore the blade 16 can be assembled into the blade base 14 in the scraping section 11. To facilitate the replacement of wallpaper or carpet, a user can use the blade 16 to remove the surface residues by grasping the stem 10 with two hands and exerting force. Further investigation into the above unknown scraper structure reveals the following drawbacks for the blade assembly.

First, the jaw plate 15 provides tightening on the jaw 13 in the scraping section 11 through the screws 17 passing the jaw plate 15 and the scraping section 11. To obtain even tightening, there have to be at least three passing screws 17. In consequence, loosening three screws 17 during replacing the blade 16 causes some inconvenience.

Second, the jaw plate 15 provides tightening for the blade 16 through passing screws 17. But the location of the blade 16 deviates from the vertical direction of force by the screws 17. In consequence, the tightening force to the blade 16 becomes insufficient. When the blade 16 is being used for scraping, it is subject to impact from the force in the opposite direction. There is a risk of loose assembly and detachment.

Third, when a user is scraping surface residues with the blade 16 in the scraping section 11 by grasping the stem with two hands, the angle between the scraping section 11 and the surface is very small. The hand grasping the front end of the stem 10 is very close to the surface, and therefore there is a risk of hurting the fingers of that hand.

The invention is to improve the above drawbacks for scraper blade assembly, which is also the motivation.

### SUMMARY OF THE INVENTION

The objective for the invention is to provide a scraper blade assembly structure. It mainly comprises a jaw plate that extends backward to form an arm and a scraping section that has a jaw plate groove to accommodate the jaw plate by a fastener, which also serves as a lever pivot. When fastening buttons are placed into the jaw plate groove in the scraping section, they are sleeved with spring to provide pushing force against the arm, and therefore the front end of the jaw plate can exert a great force to the blade. In this way, a fast replacement and firm assembly for scraper blade is achievable.

Another objective for the invention is to provide a scraper blade assembly structure that the fastening buttons in the jaw plate in the scraping section further become protruding spheres on the side of the scraping section to facilitate strong hand grasping for effective scraping.

To achieve the above objective, the scraper blade assembly structure in the invention mainly comprises a jaw plate that extends backward to form an arm to combine with the jaw plate groove of the scraping section by a fastener that also serves as a lever pivot. The arm can swing back and forth inside the jaw plate groove. The scraping section uses its terminal connecting section to connect with the stem. On one side of the scraping section, there is a jaw plate groove to accommodate the jaw plate. When the fastening button is placed inside the jaw plate groove of the scraping section, it is sleeved with a spring to provide pushing force against the arm, and therefore the front end of the jaw plate can tightly hold the plate in position with the blade base in the front of the jaw plate groove. By turning the fastening button to push against the arm, the front end of the jaw plate generates an extremely strong hold of the blade. On the other hand, by turning the fastening button to release the hold, fast replacement and firm assembly for the blade are achievable.

### DETAILED DESCRIPTION OF THE PREFERRED EMBODIMENT

A preferred embodiment is provided in the following to describe the features of the invention.

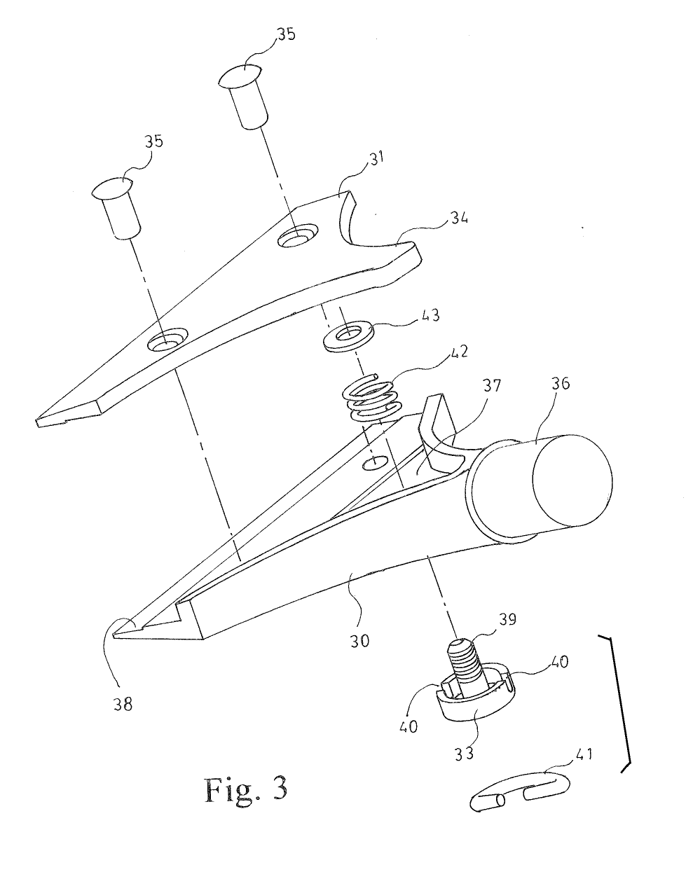

Please refer to FIGS. 3, 4, 5 and 6 for the disassembly diagram, assembly diagram and exterior diagram for the scraper blade assembly structure in the invention. In general the scraper is similar to the known types. It comprises a stem 20 for hand grip and a scraping section 30 in the front. The front end and the back end for the stem 20 are sleeved with a handle 21, 22 for each, so the user can grasp between the front and the back handles 21, 22. The scraping section 30 comprises a jaw plate 31, a blade 32 and a fastening button 33. The jaw plate 31 extends backward to form an arm 34, and is attached by two fasteners 35 to the jaw plate groove 37 of the scraping section 30, and is able to swing back and forth inside the jaw plate groove 37 by using the two fasteners 35 as lever pivot. The scraping section 30 has its terminal connecting section 36 inserted by the stem 20 to become assembled. On one side of the scraping section 30 there is a jaw plate groove 37 that fits and accommodates the jaw plate 31. In the front of the jaw plate groove 37 there is a blade base 38. The fastening button 33 has a threaded section 39 in the front and a corresponding notch 40 on each side to accommodate a switch button 41. When the fastening button 33 is attached inside the jaw plate groove 37 of the scraping section 30 by the threaded section 39, it is sleeved with a spring 42 and a stopper 43. The spring 42 provides tension to the inner side of the arm 34 of the jaw plate 31. Thus, the front of the jaw plate 31 can work with the blade base 38 in the front of the jaw plate groove 37 to hold tightly the blade 32 in position for assembly. By turning the fastening button 33 and pushing the stopper 43 against the arm 34 in the end of the jaw plate 31, a strong holding power is generated in the front of the jaw plate 31 and exerted to the blade 32. Thus, a firm blade 32 assembly is provided. On the other hand, by turning the fastening button 33 to loosen the holding power in the front of the jaw plate 31, the retrieval or replacement for the blade 32 is made easy and fast. A slot 331 made on the top surface of the fastening button 33 is mainly to facilitate its turning by a tool or the switch button 41.

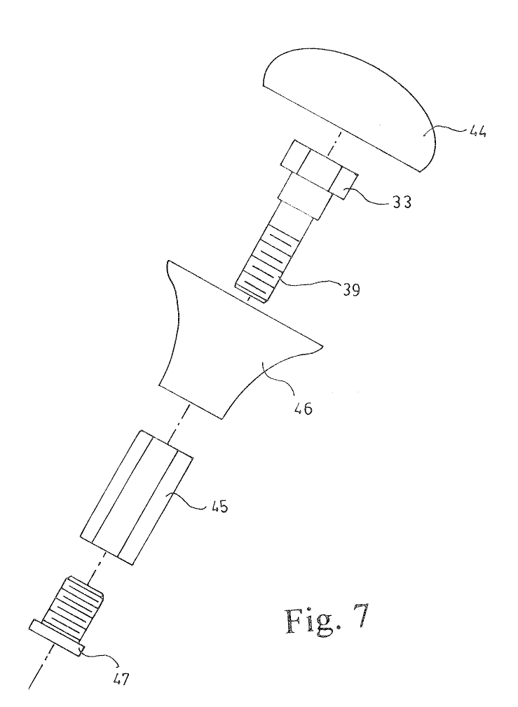

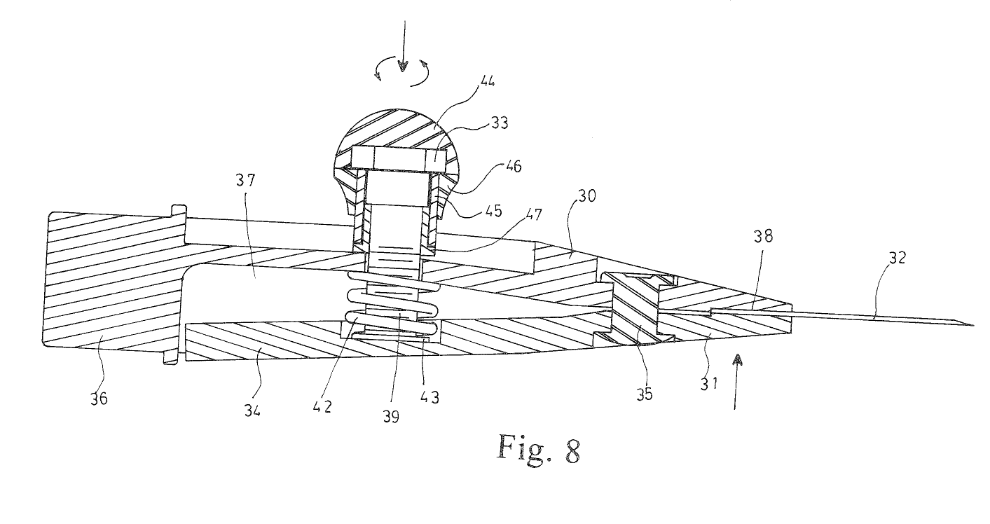

Please refer to FIGS. 7 and 8 for another preferred embodiment for the fastening button of the invention. The fastening button 33 has a molded knob 44 on its top, a sleeve 45 and a handle 46, which are integrated as one. An axle 47 connects in the bottom of the sleeve 45. The fastening button 33 goes into the sleeve 45 and leaves its threaded section 39 outside the axle 47. The fastening button 33 uses its threaded section 39 to attach to the jaw plate groove 37 of the scraping section 30 and is also sleeved with a spring 42 and a stopper 43. So it can provide fast replacement and firm assembly for the scraper blade 32. At this moment, the knob 44 and the handle 46 are combined to form a spherical fastening button 33. Besides, the relative movement between the handle 46 and the knob 44 does not affect the attachment. As a result, a user may exert a stronger force with hand grasping the front to achieve effective scraping and assure operation safety.

The above disclosed figures and description are only the preferred embodiments for the invention. The modifications or equivalent applications by people familiar with the arts, such as using a wedge or a cam to be the device that generates vertical pushing force for the fastening button in the jaw plate groove of the scraping section, are not outside the scope of the invention and shall be covered by the claims.

### Specific Drawing

(1) The designated diagram for the present invention is Figure (3).
(2) The legends for the components

| | | | | | |
|---|---|---|---|---|---|
| 30 | scraping section | 31 | jaw plate | 33 | fastening button |
| 34 | arm | 35 | fastener | 36 | connecting section |
| 37 | jaw plate groove | 38 | blade base | 39 | threaded section |
| 40 | notch | 41 | switch button | 42 | spring |
| 43 | stopper | | | | |

### BRIEF DESCRIPTION OF THE DRAWINGS

FIG. 1 is a structure disassembly diagram for a common scraper.

FIG. 2 is an exterior assembly diagram for a common scraper.

FIG. 3 is a structure disassembly diagram for the scraper blade assembly for the invention.

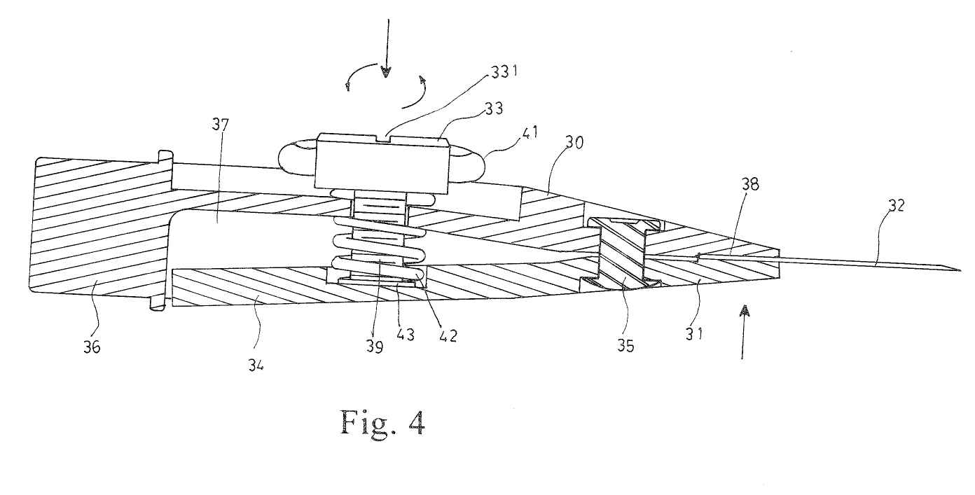

FIG. 4 is a cross-sectional diagram for the scraper blade assembly for the invention.

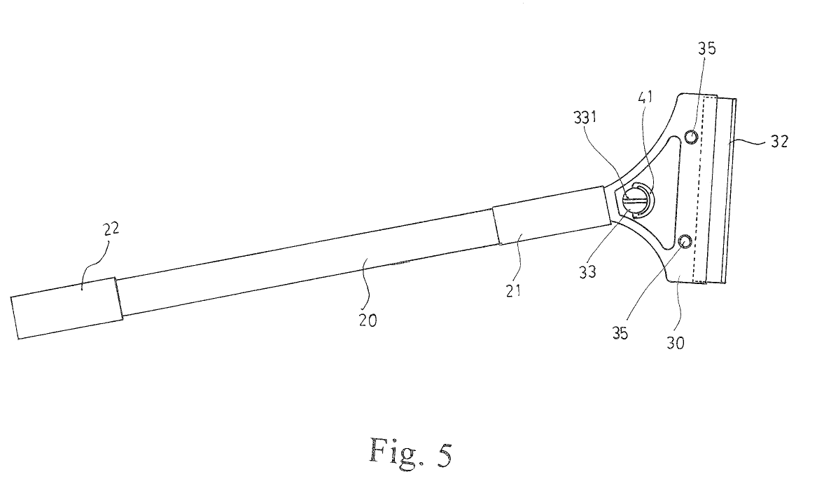

FIG. 5 is an exterior view diagram for the scraper blade assembly for the invention.

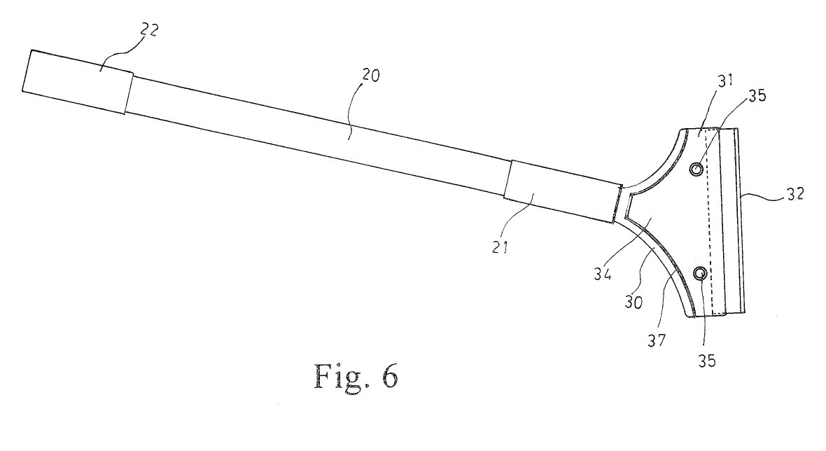

FIG. 6 is another exterior view diagram for the scraper blade assembly for the invention.

FIG. 7 is a disassembly diagram for another embodiment of the fastening button for the invention.

FIG. 8 is a cross-sectional diagram for the fastening button for another embodiment for the invention.

Description of Main Components

| | | | | | |
|---|---|---|---|---|---|
| 10 | stem | 11 | scraping section | 12 | connecting |
| | | | | | section |
| 13 | jaw | 14 | blade base | 15 | jaw plate |
| 16 | blade | 17 | screws | 20 | stem |
| 21 | Front handle | 22 | Back handle | 30 | scraping section |
| 31 | jaw plate | 32 | blade | 33 | fastening button |
| 331 | slot | 34 | arm | 35 | fastener |
| 36 | connecting | 37 | jaw plate | 38 | blade |
| | section | | groove | | base |
| 39 | threaded section | 40 | notch | 41 | switch button |
| 42 | spring | 43 | stopper | 44 | knob |
| 45 | sleeve | 46 | handle | 47 | axle |

What is claimed is:

1. A scraper blade assembly structure comprises a stem for hand grip and a scraping section in the front. It features are that the scraping section comprises a jaw plate, a blade and a fastening button. The scraping section has a jaw plate groove on one side to have the similar shape to the jaw plate. The jaw plate groove has a blade base in the front. The jaw plate extends backward to form an arm that is attached to the inside of the jaw plate groove of the scraping section by two fasteners and become a lever pivot for swinging back and forth. The fastening button has a threaded section in the front to attach to the inside of the jaw plate groove of the scraping section and is sleeved with a spring and a stopper. With the tension provides by the spring on the arm of the jaw plate and the pushing force by the fastening button on the arm of the jaw plate, the front of the jaw plate generates a holding power for the blade, and so as to constitute a scraper blade assembly structure.

2. According to claim 1 for a scraper blade assembly structure, the fastening button has a corresponding notch on each side to accommodate a switch button, and so as to facilitate the operation of the fastening button in pushing or turning.

3. According to claim 1 for a scraper blade assembly structure, the top surface of the fastening button has a slot to facilitate the operation of the fastening button in pushing or turning.

4. According to claim 1 for a scraper blade assembly structure, the fastening button can be a device of a wedge, a cam or anything to produce vertical pushing force.

5. According to claim 1 for a scraper blade assembly structure, the fastening button has a molded knob, a sleeve and a handle integrated as one on its top. In the bottom of the sleeve there is an axle. When the fastening button goes into the sleeve, its threaded section is left outside the axle. The fastening button is attached to the inside of the jaw plate groove of the scraping section by the threaded section and is also sleeved with a spring and a stopper to provide fast replacement and firm assembly for the scraper blade.

6. According to claim 5 for a scraper blade assembly structure, the knob and the handle are combined to form a fastening button, which can be a sphere protruding from one side of the scraping section or a shape for hand grip to facilitate the user to exert stronger force for effective scraping.
